(19) United States
(12) Patent Application Publication
(10) Pub. No.: US 2025/0373178 A1
(43) Pub. Date: Dec. 4, 2025

(54) ELECTRIC POWER CONVERSION APPARATUS

(71) Applicant: FUJI ELECTRIC CO., LTD., Kanagawa (JP)

(72) Inventor: Hirofumi UEMURA, Tokyo (JP)

(21) Appl. No.: 19/247,348

(22) Filed: Jun. 24, 2025

Related U.S. Application Data
(63) Continuation of application No. PCT/JP2024/026665, filed on Jul. 25, 2024.

(30) Foreign Application Priority Data
Jul. 27, 2023 (JP) 2023-122541

(51) Int. Cl. H02M 7/539

(52) U.S. Cl. CPC H02M 7/539

(57) ABSTRACT

An electric power conversion apparatus includes an inverter configured to convert input DC power into AC power, and a control device configured to control the inverter, wherein the control device is configured to prioritize limiting one of an active current and a reactive current output from the inverter over the other of the active current and the reactive current, so that an apparent current output from the inverter becomes less than or equal to a limit value.

### CROSS-REFERENCE TO RELATED APPLICATIONS

This application is a continuation application of International Application No. PCT/JP2024/026665 filed on Jul. 25, 2024 and designated the U.S., which is based upon and claims priority to Japanese Patent Application No. 2023-122541, filed on Jul. 27, 2023, the entire contents of which are incorporated herein by reference.

### FIELD

The present disclosure relates to electric power conversion apparatuses.

### BACKGROUND

An electric power converter applied with a voltage controlled virtual synchronous generator control may stop due to a converter overcurrent in a case where a system disturbance or overload occurs, and there are demands for a control method for preventing such a stop and continuing operation. The virtual synchronous generator control can roughly classified into a voltage control type and a current control type, and in the case of the current control type, there is a method for controlling the current to an arbitrary value by limiting a current command value. However, in the case of the voltage control type, because a method for controlling a voltage command value cannot control the current to an arbitrary value, an overcurrent may occur depending on conditions such as a system impedance or the like. Accordingly, a known electric power conversion apparatus performs a voltage control type virtual synchronous generator control during a normal operation, and suppresses the overcurrent by a current control in a case where an output overcurrent occurs (refer to Japanese Laid-Open Patent Publication No. 2021-141704, for example).

As a function for stabilizing frequency and voltage of the system by inverter control, there is a function of outputting an active current for frequency stabilization and outputting a reactive current for voltage stabilization. In a case where a frequency disturbance of the system is large, it is desirable to output the active current as much as possible, and in a case where the voltage disturbance of the system is large, it is desirable to output the reactive current as much as possible.

However, in a case where the active current output and the reactive current output are limited uniformly at the same ratio, both the frequency stabilization and the voltage stabilization are affected thereby. For this reason, even in a case where the frequency of the system is stable, the active current is limited, and even in a case where the voltage of the system is stable, the reactive current is limited, for example.

### SUMMARY

One aspect of the present disclosure provides an electric power conversion apparatus that can stabilize the frequency or voltage of the system while suppressing the overcurrent.

An electric power conversion apparatus according to an aspect of the present disclosure includes an inverter configured to convert input DC power into AC power; and a control device configured to control the inverter, wherein the control device is configured to prioritize limiting one of an active current and a reactive current output from the inverter over the other of the active current and the reactive current, so that an apparent current output from the inverter becomes less than or equal to a limit value.

The electric power conversion apparatus according to an aspect of the present disclosure may be configured to prioritize limiting the active current over the reactive current, so that the apparent current becomes less than or equal to the limit value in a case where a disturbance occurs in an amplitude of an output voltage from the inverter.

An electric power conversion apparatus according to another aspect of the present disclosure includes an inverter configured to convert input DC power into AC power; and a control device configured to control the inverter, wherein the control device is configured to reduce one of an active current and a reactive current output from the inverter with a gain greater than that of the other of the active current and the reactive current, so that an apparent current output from the inverter becomes less than or equal to a limit value.

### BRIEF DESCRIPTION OF THE DRAWINGS

FIG. 1 is a diagram illustrating a configuration example of an electric power conversion apparatus;

FIG. 2 is a diagram illustrating configuration examples of an inverter and a control device in the electric power conversion apparatus according to the first embodiment;

FIG. 3 is a functional block diagram illustrating an example of a current command limitation unit;

FIG. 4 is a vector diagram for explaining a current command limitation in an apparent current limitation mode;

FIG. 5 is a functional block diagram illustrating an example of an apparent current limitation unit;

FIG. 6 is a vector diagram for explaining a current command limitation in an active current limitation mode;

FIG. 7 is a functional block diagram illustrating an example of an active current limitation unit;

FIG. 8 is a vector diagram for explaining a current command limitation in a reactive current limitation mode;

FIG. 9 is a functional block diagram illustrating an example of a reactive current limitation unit;

FIG. 10 is a functional block diagram illustrating an example of a mode selector;

FIG. 11 is a diagram illustrating configuration examples of the inverter and the control device in the electric power conversion apparatus according to a second embodiment;

FIG. 12 is a functional block diagram illustrating an example of a frequency control unit in the control device;

FIG. 13 is a functional block diagram illustrating an example of a voltage amplitude control unit in the control device;

FIG. 14 is a functional block diagram illustrating an example of an instantaneous voltage command unit in the control device;

FIG. 15 is a functional block diagram illustrating an example of an instantaneous current command unit in the control device; and

FIG. 16 is a functional block diagram illustrating an example of an instantaneous current control unit in the control device.

### DESCRIPTION OF EMBODIMENTS

Hereinafter, embodiments will be described.

### <Overall Schematic Configuration of Electric Power Conversion Apparatus>

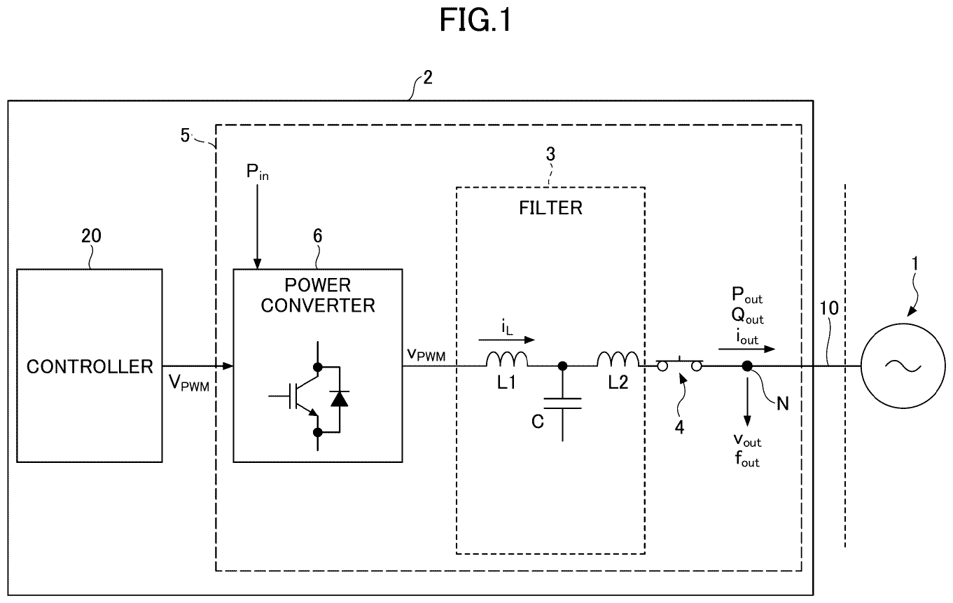

FIG. 1 is a diagram illustrating a configuration example of an electric power conversion apparatus. An electric power conversion apparatus 2 illustrated in FIG. 1 is interconnected to a power system 1. The power system 1 is a power system configured to supply AC power generated by a power plant to a facility of a consumer via a power distribution line 10.

The electric power conversion apparatus 2 is an apparatus configured to input power from and output power to the power system 1. The electric power conversion apparatus 2 includes an inverter 5 configured to input power from and output power to the power system 1, and a control device 20 configured to operate the inverter 5 as a Grid Following (GFL) inverter or a Grid Forming (GEM) inverter.

The inverter 5 is a device configured to convert input DC power into AC power. The inverter 5 is an Inverter Based Resource (IBR) configured to convert DC power generated from renewable energy, such as sunlight or the like, into AC power, and operates in cooperation with the power system 1. The inverter 5 includes a power converter 6, a filter 3, and a switch 4.

The power converter 6 converts input DC power Pin (for example, DC power generated from renewable energy) into AC power, according to a pulse width modulation signal (a PWM pulse signal V_{PWM}) supplied from the control device 20. The power converter 6 outputs a voltage V_{PWM} corresponding to an AC voltage, according to the PWM pulse signal V_{PWM}. The power converter 6 is connected to the power system 1 via the filter 3 and the switch 4.

The filter 3 removes harmonic components of a current flowing between the power converter 6 and the power system 1. The filter 3 receives an AC current i_{L} output from the power converter 6. The filter 3 outputs an output current iₒᵤₜ with the harmonic components removed from the current i_{L} to the power system 1.

The filter 3 is an LCL filter including a reactor L1, a reactor L2, and a capacitor C, for example. The reactor L1 and the reactor L2 are connected to each other in series. The reactor L1 is connected to an output side of the power converter 6, and the reactor L2 is connected to the side of the power system 1.

One end of the capacitor C is connected between the reactor L1 and the reactor L2. The other end of the capacitor C is connected to a neutral point of a three-phase system (not illustrated). The other end of the capacitor C may be grounded. Further, a delta-connection (a Δ-connection) may be used instead of a Y-connection (a start connection).

Because the reactor L1 is present between the power converter 6 and the capacitor C, a differential voltage between an output voltage of the power converter 6 and a voltage of the capacitor C is generated in the reactor L1. The current i_{L} flowing through the reactor L1 is determined from the differential voltage and an impedance of the reactor L1. By using such properties, the control device 20 can control the current i_{L} by controlling the voltage VIM output from the power converter 6.

The switch 4 is connected between the power system 1 and the power converter 6. The switch 4 may be referred to as an interconnection switch.

When the power system 1 is in a normal state, the switch 4 is in an on state, and the inverter 5 can exchange power with the power system 1. When an abnormality, such as a failure or the like, occurs in the power system 1, the switch 4 is switched from the on state to an off state, and the inverter 5 is disconnected from the power system 1. The switch 4 is controlled to the on state or the off state by the control device 20, for example.

Specifically, the inverter 5 is a device configured to output active power Pₒᵤₜ with respect to the power system 1, by controlling the voltage V_{PWM} according to a frequency fₒᵤₜ of an output voltage Vₒᵤₜ or an output of the active power Pₒᵤₜ and reactive power Lout at a node N connected to the power distribution line 10. The active power Pₒᵤₜ, if positive, is the active power output from the inverter 5 to the power system 1, and if negative, is the active power input to the inverter 5 from the power system 1.

Functions of the control device 20 are implemented by a processor, such as a Central Processing Unit (CPU) or the like, configured to operate according to a program stored in a memory. The functions of the control device 20 may be implemented by a Field Programmable Gate Array (FPGA) or an Application Specific Integrated Circuit (ASIC). Further, the functions of the control device 20 may be implemented by an analog circuit using an operational amplifier or the like.

### First Embodiment

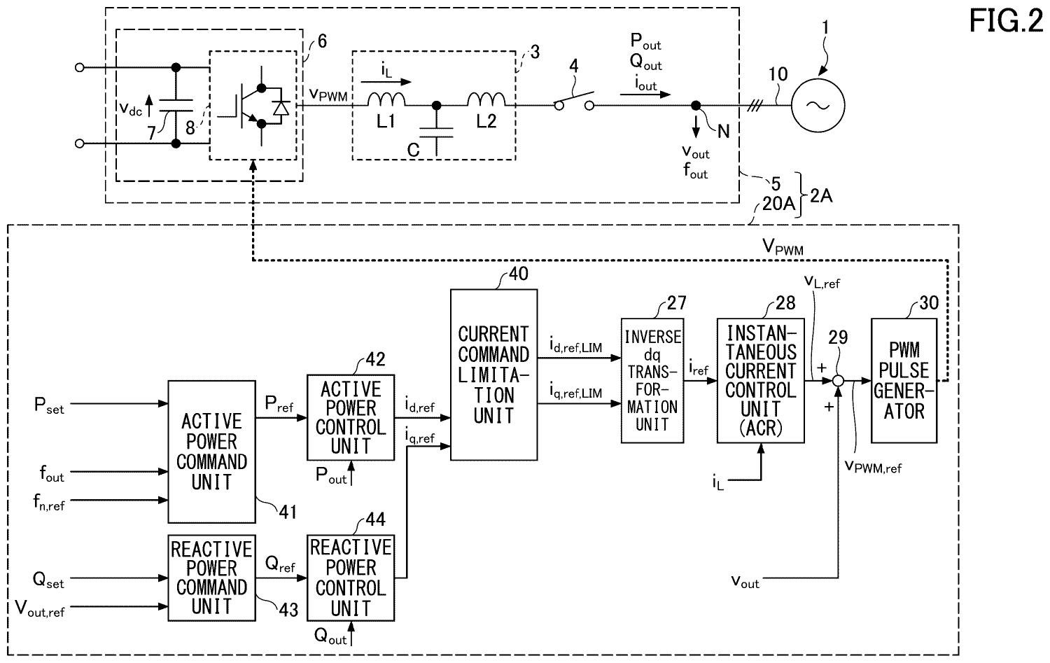

FIG. 2 is a diagram illustrating configuration examples of the inverter and the control device in the electric power conversion apparatus according to a first embodiment. FIG. 2 illustrates a circuit configuration of the inverter 5 and functional blocks of a control device 20A. An electric power conversion apparatus 2A according to the first embodiment is an example of the electric power conversion apparatus 2 described above. The electric power conversion apparatus 2A includes the inverter 5, and the control device 20A. The control device 20A controls the inverter 5 by a current control method.

The inverter 5 includes a power converter 6, a filter 3, and a switch 4. The power converter 6 includes a capacitor 7, and an inverter circuit 8.

The capacitor 7 smoothens a DC voltage input from an external device, such as a power generator or the like, configured to generate power using renewable energy, such as sunlight or the like, and stores the input energy. A DC voltage Vac corresponds to a voltage of the capacitor 7 (capacitor voltage).

The inverter circuit 8 is an inverter circuit configured to convert DC power input from the external device, such as the power generator or the like, into AC power. The inverter circuit 8 converts the DC voltage Vdc smoothened by the capacitor 7 into an AC voltage V_{PWM} and outputs the AC voltage V_{PWM}.

The control device 20A controls the inverter 5 by a current control method. The control device 20A includes an active power command unit 41, an active power control unit 42, a reactive power command unit 43, a reactive power control unit 44, a current command limitation unit 40, an inverse dq transformation unit 27, an instantaneous current control unit 28, an adder 29, and a PWM pulse generator 30.

The active power command unit 41 is configured to generate an active power command value P_{ref} that is a command value of active power output from the inverter 5 to the power system 1. The active power command unit 41 is configured to calculate and output the active power command value P_{ref} based on, an active power set value Pₛₑₜ, a frequency measurement value fₒᵤₜ, and a rated frequency setting value f_{n,ref}, for example.

The active power set value Pₛₑₜ is a reference value of the active power Pₒᵤₜ, and is a value set by a person. In a case where a DC-side power generator electrically connected to the capacitor 7 is a solar cell, the active power set value Pₛₑₜ is set to a value less than or equal to the active power that can be generated by the solar cell. The active power set value Pₛₑₜ may be set automatically by a control (Maximum Power Point Tracking (MPPT)) for automatically obtaining a maximum power point at which a solar cell power generation can be maximized. In a case where a storage battery is provided on the DC-side, the active power set value Pₛₑₜ at a time of charging or discharging of the storage battery may be set according to a State of Charge (SOC) of the storage battery. The frequency measurement value fₒᵤₜ is a measurement value of a frequency of the output voltage Vₒᵤₜ actually output from the inverter 5 to the power system 1. The frequency measurement value fₒᵤₜ is the measurement value at the node N between the filter 3 and the power system 1. The rated frequency setting value f_{n,ref} is a set value of a rated frequency of the power system 1. For example, the rated frequency setting value f_{n,ref} of 50 Hz is adopted in Eastern Japan, and the rated frequency setting value f_{n,ref} of 60 Hz is adopted Western Japan.

The active power control unit 42 is configured to control the active power Pₒᵤₜ output from the inverter to the power system 1. The active power control unit 42 is configured to perform an instantaneous power control to control the active power Pₒᵤₜ output from the inverter 5 to the power system 1 to approach the active power command value P_{ref}. The active power control unit 42 is configured to perform a PI control in which the active power Pₒᵤₜ is sampled as instantaneous active power, and a feedback control is performed so that the active power measurement value Pₒᵤₜ, which is the sampled value, matches the active power command value P_{ref}, for example. In the PI control, P represents a proportional control, and I represents an integral control. The active power measurement value Pₒᵤₜ is a measurement value of the active power Pₒᵤₜ output from the inverter 5 to the power system 1.

The active power control unit 42 is configured to generate a d-axis current command value i_{d,ref} based on the active power command value P_{ref} and the active power measurement value Pₒᵤₜ, so that the active power measurement value Pₒᵤₜ approaches the active power command value P_{ref}. The d-axis current command value i_{d,ref} is a command value of an active current output from the inverter 5 to the power system 1. The d-axis current command value i_{d,ref} is an example of a first current command value, and contributes to the active power output from the inverter 5 to the power system 1.

The reactive power command unit 43 is configured to generate a reactive power command value Q_{ref}, which is a command value of reactive power output from the inverter 5 to the power system 1. The reactive power command unit 43 is configured to calculate and output the reactive power command value Q_{ref}, based on a reactive power setting value Qₛₑₜ and an output voltage amplitude command value V_{out,ref}, for example.

The reactive power setting value Qₛₑₜ is a reference value of the reactive power Qₒᵤₜ, and is a value set by a person. In a case where a solar inverter performs a constant power factor control, the reactive power setting value Qₛₑₜ may be set to a value of the reactive power to be output, which is calculated based on a value of a power factor set by a person and a value of the active power measurement value Pₒᵤₜ currently being output. The output voltage amplitude command value V_{out,ref} is a command value of an amplitude of the output voltage Vₒᵤₜ output from the inverter 5 to the power system 1.

The reactive power control unit 44 is configured to control the reactive power Cout output from the inverter 5 to the power system 1. The reactive power control unit 44 is configured to perform an instantaneous power control to control the reactive power Qₒᵤₜ output from the inverter 5 to the power system 1 to approach the reactive power command value Q_{ref}. The reactive power control unit 44 is configured to perform a PI control in which the reactive power Cout is sampled as instantaneous active power, and a feedback control is performed so that the reactive power measurement value Cout, which is the sampled value, matches the reactive power command value Q_{ref}. The reactive power measurement value Qₒᵤₜ is a measurement value of the reactive power Cout output from the inverter 5 to the power system 1.

The reactive power control unit 44 is configured to generate a q-axis current command value i_{q,ref} based on the reactive power command value Q_{ref} and the reactive power measurement value Qₒᵤₜ, so that the reactive power measurement value Qₒᵤₜ approaches the reactive power command value Q_{ref}. The q-axis current command value i_{q,ref} is a command value of a reactive current output from the inverter 5 to the power system 1. The q-axis current command value i_{q,ref} is an example of a second current command value, and contributes to the reactive power output from the inverter 5 to the power system 1.

The current command limitation unit 40 is configured to generate a d-axis current command value i_{d,ref,LIM} with the d-axis current command value i_{d,ref} limited, and generate a q-axis current command value i_{q,ref,LIM} with the q-axis current command value i_{q,ref} limited, in order to suppress an overcurrent flowing in the power system 1. The current command limitation unit will be described later in more detail.

The inverse dq transformation unit 27 is configured to perform an inverse dq transformation of a two-axis current command value (the d-axis current command value i_{d,ref,LIM} and the q-axis current command value i_{q,ref,LIM}) into a three-phase output current command value i_{ref}, and output the output current command value i_{ref}. The output current command value i_{ref} is a three-phase command value of the current i_{L} output from the inverter circuit 8 to the filter 3.

The instantaneous current control unit 28 is configured to control the current i_{L} output from the inverter circuit 8 to the filter 3. The instantaneous current control unit 28 is configured to perform an instantaneous current control to control the current i_{L} output from the inverter circuit 8 to the filter 3 to approach the output current command value i_{ref}. The instantaneous current control unit 28 may be configured as an Automatic Current Regulator (ACR), for example, which samples the current i_{L} as an instantaneous current and performs a feedback control so that the current measurement value i_{L} which is the sampled value, matches the output current command value i_{ref}. The current measurement value it is a measurement value of a three-phase instantaneous current flowing from the inverter circuit 8 to the reactor L1 of the filter 3.

The instantaneous current control unit 28 is configured to generate an output voltage correction value V_{L,ref} based on the output current command value i_{ref} and the current measurement value i_{L} so that the current measurement value i_{L} approaches the output current command value i_{ref}. The output voltage correction value V_{L,ref} is added to the output voltage measurement value Vₒᵤₜ by the adder 29, in order to correct the output voltage measurement value Vₒᵤₜ, which is a measurement value of the three-phase output voltage output from the inverter 5 to the power system 1.

The adder 29 is configured to output a value obtained by adding the output voltage correction value V_{L,ref} to the output voltage measurement value Vₒᵤₜ, as a PWM command value V_{PWM,ref}.

The PWM pulse generator 30 is configured to compare the PWM command value V_{PWM,ref} with a carrier signal, such as a triangular wave or the like, and generate the PWM pulse signal VIM including a PWM pulse. The pulse width modulation method is not limited to the triangular wave comparison modulation method, and a generally used pulse width modulation method may be utilized. Of course, a required number of PWM pulses needs to be generated depending on the configuration of the inverter circuit 8.

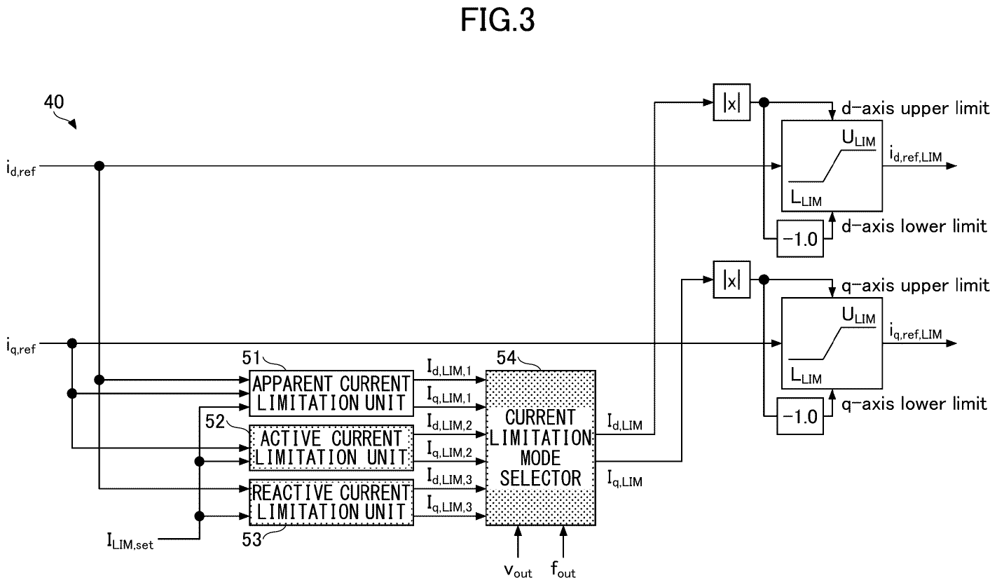

FIG. 3 is a functional block diagram illustrating an example of the current command limitation unit. The current command limitation unit 40 has a plurality of current limitation modes (an apparent current limitation mode, an active current limitation mode, and a reactive current limitation mode) that can be switched during operation of the inverter 5, in order to suppress the overcurrent flowing in the power system 1. The current command limitation unit 40 is configured to switch the current limitation mode manually or automatically. For example, the current command limitation unit 40 basically operates in the apparent current limitation mode, operates in the active current limitation mode in a case where an amplitude fluctuation of the output voltage Vₒᵤₜ exceeding a reference is detected, and operates in the reactive current limitation mode in a case where a frequency fluctuation of the output voltage Vₒᵤₜ exceeding a reference is detected.

The current command limitation unit 40 includes an apparent current limitation unit 51, an active current limitation unit 52, a reactive current limitation unit 53, and a mode selector 54.

The apparent current limitation unit 51 is configured to generate dq-axis current command limit values (a d-axis current command limit value i_{d,LIM,1} and a q-axis current command limit value i_{q,LIM,1}) set during operation in the apparent current limitation mode. The d-axis current command limit value i_{d,LIM,1} is a value for limiting the d-axis current command value i_{d,ref} in the apparent current limitation mode. The q-axis current command limit value i_{q,LIM,1} is a value for limiting the q-axis current command value i_{q,ref} in the apparent current limitation mode.

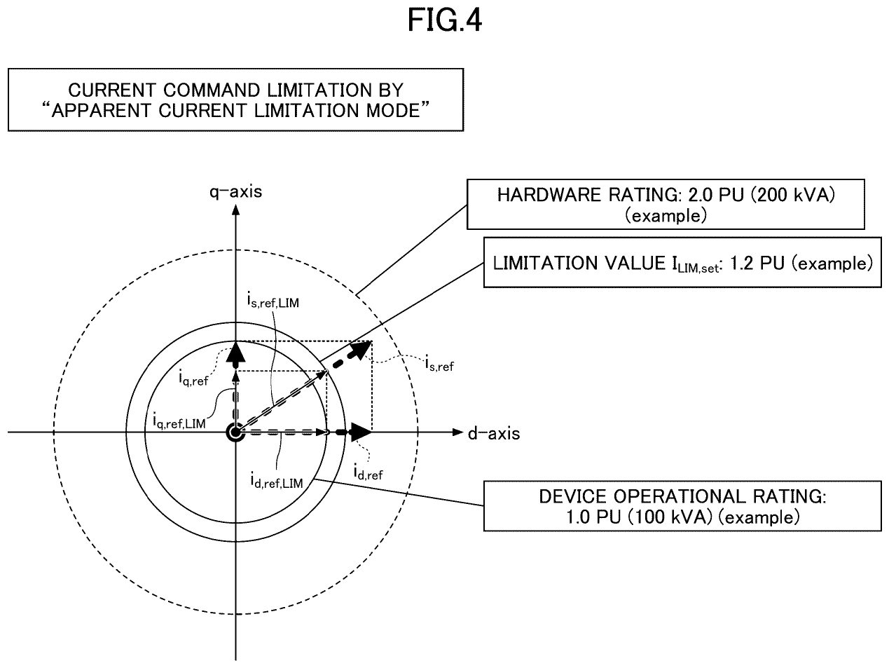

FIG. 4 is a vector diagram for explaining the current command limitation in the apparent current limitation mode. The apparent current limitation unit 51 is configured to limit the d-axis current command value I_{d,ref} and the q-axis current command value i_{q,ref} at the same ratio, so that an apparent current command value i_{s,ref} becomes less than or equal to a limit value I_{LIM,set}. The limit value I_{LIM,set} is set higher than or equal to an operational rating of the inverter 5, and lower than or equal to a hardware rating of the inverter 5.

The apparent current command value i_{s,ref} satisfies the following relationship.

i_{s,ref}=√((i_{d,ref})²+(i_{q,ref})²)

The apparent current limitation unit 51 is configured to calculate an apparent current command value i_{s,ref} before the limitation, using the dq-axis current command values (the d-axis current command value i_{d,ref} and the q-axis current command value i_{q,ref}) before the limitation. The apparent current limitation unit 51 is configured to calculate a current command suppression gain K, by dividing the limit value I_{LIM,set} by the apparent current command value i_{s,ref} before the limitation. The apparent current limitation unit 51 is configured to calculate the d-axis current command limit value i_{d,LIM,1} by multiplying the current command suppression gain K to the d-axis current command value i_{d,ref} before the limitation. The apparent current limitation unit 51 is configured to calculate the q-axis current command limit value i_{q,LIM,1} by multiplying the current command suppression gain K to the q-axis current command value i_{q,ref} before the limitation. Accordingly, the apparent current command value i_{s,ref} before the limitation is limited to an apparent current command value i_{s,ref,LIM} in which a magnitude of a vector of the current command value is suppressed within a circle having a radius (the limit value I_{LIM,set}), thereby suppressing the overcurrent.

As described above, the control device 20A is configured to reduce the active current and the reactive current by identical gains, so that the apparent current becomes less than or equal to the limit value.

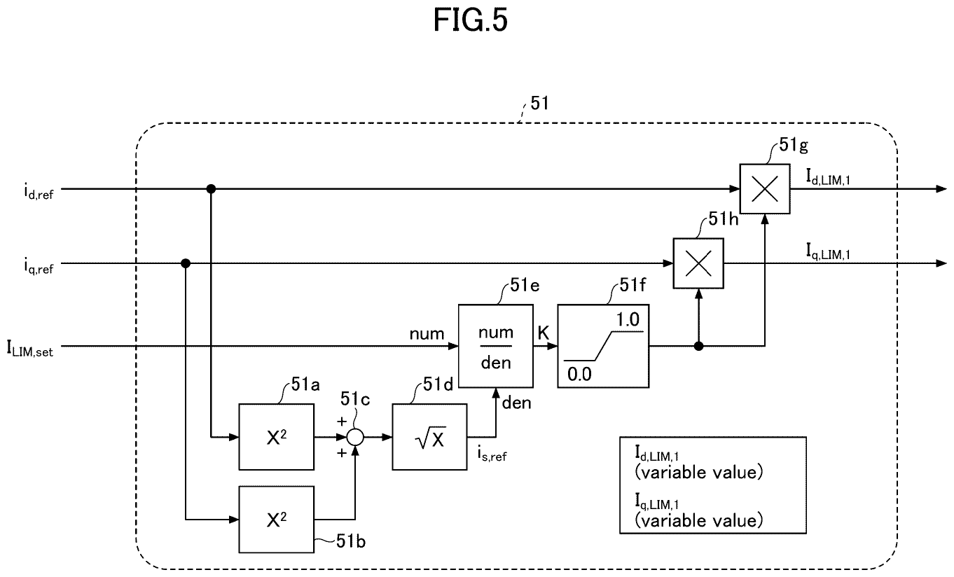

FIG. 5 is a functional block diagram illustrating an example of the apparent current limitation unit. The apparent current limitation unit 51 includes multipliers 51a and 51b, an adder 51c, an arithmetic unit 51d, a division unit 51e, a limitation unit 51f, and multipliers 51g and 51h.

The multipliers 51a and 51b, the adder 51c, and the arithmetic unit 51d are configured to calculate the apparent current command value i_{s,ref} by vector synthesis of the d-axis current command value i_{d,ref} and the q-axis current command value i_{q,ref}. The division unit 51e is configured to calculate the current command suppression gain K by dividing a predetermined limit value I_{LIM,set} by the apparent current command value i_{s,ref} before the limitation. The limitation unit 51f is configured to output the current command suppression gain K, which is limited to 0 or greater and 1 or less, to the multiplier 51g and the multiplier 51h. The multiplier 51g is configured to output a value obtained by multiplying the current command suppression gain K to the d-axis current command value i_{d,ref} before the limitation, as the d-axis current command limit value I_{d,LIM,1}. The multiplier 51h is configured to output a value obtained by multiplying the current command suppression gain K to the q-axis current command value i_{q,ref} before the limitation, as the q-axis current command limit value I_{q,LIM,1}.

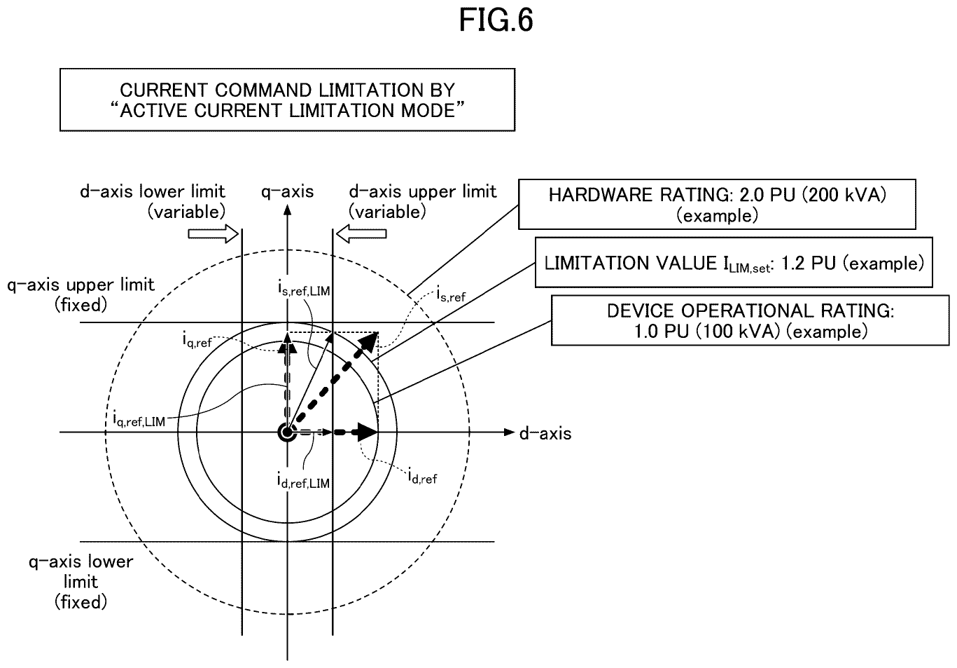

FIG. 6 is a vector diagram for explaining the current command limitation in the active current limitation mode. The active current limitation unit 52 is configured to prioritize limiting the d-axis current command value i_{d,ref} over the q-axis current command value i_{q,ref}, so that the apparent current command value i_{s,ref} becomes less than or equal to a limit value i_{LIM,set}. Because the q-axis current command value i_{q,ref} is smaller than the limit value i_{LIM,set}, the active current limitation unit 52 does not limit the q-axis current command value i_{q,ref}. The active current limitation unit 52 is configured to output the limit value I_{LIM,set} as a q-axis current command limit value I_{q,LIM,2}. The active current limitation unit 52 is configured to calculate a d-axis current command limit value I_{d,LIM,2} (a d-axis current command value I_{d,ref,LIM}) at which the apparent current command value i_{s,ref} becomes less than or equal to the limit value I_{LIM,set}. Thus, the apparent current command value i_{s,ref} before the limitation is limited to the apparent current command value I_{s,ref,LIM} in which a magnitude of a vector of the current command value is suppressed within a circle having a radius (the limit value I_{LIM,set}), thereby suppressing the overcurrent.

Accordingly, the control device 20A is configured to reduce the active current by a gain greater than that of the reactive current, so that the apparent current becomes less than or equal to the limit value. Hence, the limiting of the d-axis current command value contributing to the active current is prioritized, and the q-axis current command value contributing to the reactive current for the voltage stabilization is set to be greater than the d-axis current command value.

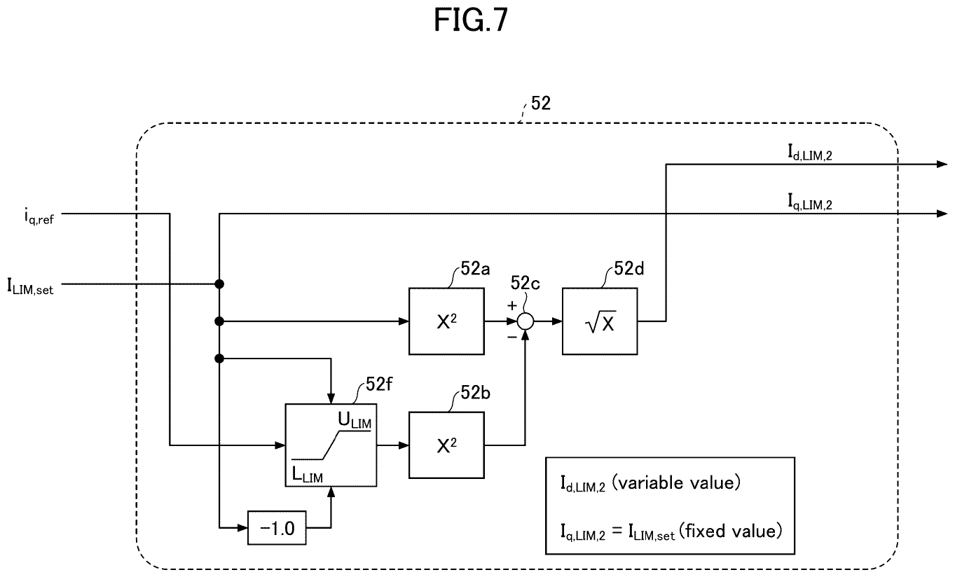

FIG. 7 is a functional block diagram illustrating an example of the active current limitation unit. The active current limitation unit 52 includes multipliers 52a and 52b, an adder 52c, an arithmetic unit 52d, and a limitation unit 52f.

The limitation unit 52f is configured to output the q-axis current command value i_{q,ref} limited to be greater than or equal to a lower limit value (−I_{LIM,set}) and less than or equal to an upper limit value (+I_{LIM,set}). The multipliers 52a and 52b, the adder 52c, and the arithmetic unit 52d are configured to calculate the d-axis current command limit value I_{d,LIM,2} (the d-axis current command value i_{d,ref,LIM}) at which the apparent current command value i_{s,ref} becomes the limit value I_{LIM,set}. The active current limitation unit 52 is configured to output the limit value I_{LIM,set} as the q-axis current command limit value I_{q,LIM,2}.

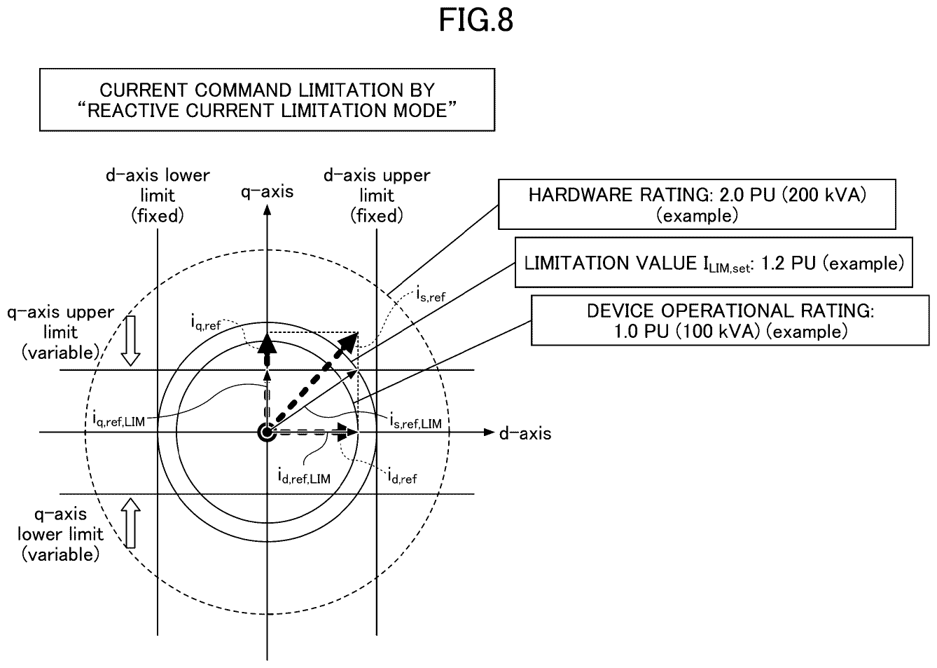

FIG. 8 is a vector diagram for explaining the current command limitation in the reactive current limitation mode. The reactive current limitation unit 53 is configured to prioritize limiting the q-axis current command value i_{q,ref} over the d-axis current command value i_{d,ref}, so that the apparent current command value i_{s,ref} becomes less than or equal to the limit value i_{LIM,set}. Because the d-axis current command value i_{d,ref} becomes smaller than the limit value i_{LIM,set}, the reactive current limitation unit 53 does not limit the d-axis current command value i_{d,ref}. The reactive current limitation unit 53 is configured to output the limit value I_{LIM,set} as a d-axis current command limit value I_{d,LIM,3}. The reactive current limitation unit 53 is configured to calculate a q-axis current command limit value I_{q,LIM,3} (a q-axis current command value I_{q,ref,LIM}) at which the apparent current command value i_{s,ref} becomes less than or equal to the limit value I_{LIM,set}. Thus, the apparent current command value i_{s,ref} before the limitation is limited to the apparent current command value i_{s,ref,LIM} in which a magnitude of a vector of the current command value is suppressed within a circle having a radius (the limit value I_{LIM,set}), thereby suppressing the overcurrent.

Accordingly, the control device 20A is configured to reduce the reactive current with a gain greater than that of the active current, so that the apparent current becomes less than or equal to the limit value. Hence, the limiting of the q-axis current command value contributing to the reactive current is prioritized, and the limiting of the d-axis current command value contributing to the active current for the frequency stabilization is set to be greater than the q-axis current command value.

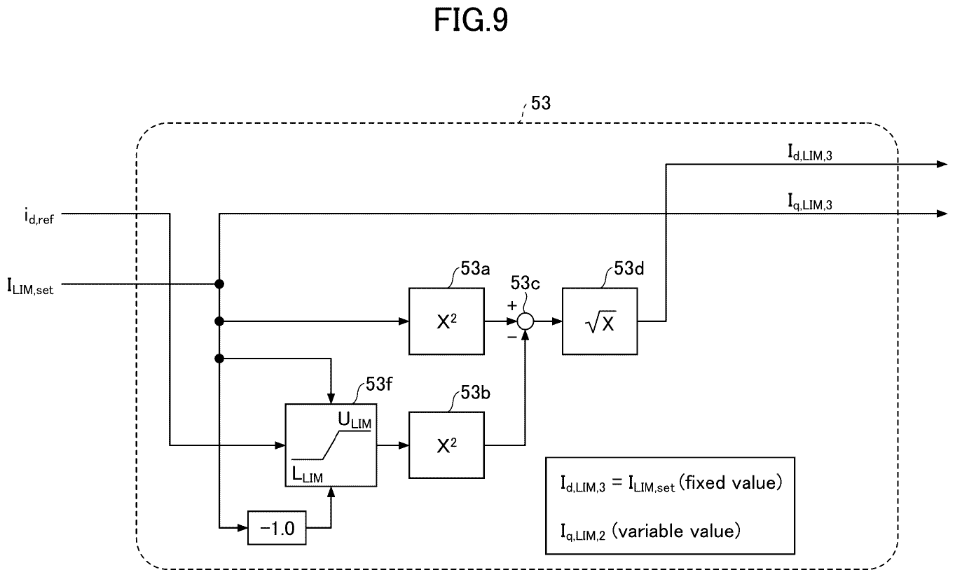

FIG. 9 is a functional block diagram illustrating an example of the reactive current limitation unit. The reactive current limitation unit 53 includes multipliers 53a and 53b, an adder 53c, an arithmetic unit 53d, and a limitation unit 53f.

The limitation unit 53f is configured to output the d-axis current command value i_{d,ref} limited to be greater than or equal to the lower limit value (−I_{LIM,set}) and less than or equal to the upper limit value (+I_{LIM,set}). The multipliers 53a and 53b, the adder 53c, and the arithmetic unit 53d are configured to calculate the q-axis current command limit value I_{q,LIM,3} (the q-axis current command value i_{q,ref,LIM}) at which the apparent current command value i_{s,ref} becomes the limit value I_{LIM,set}. The reactive current limitation unit 53 is configured to output the limit value I_{LIM,set} as the d-axis current command limit value I_{d,LIM,3}.

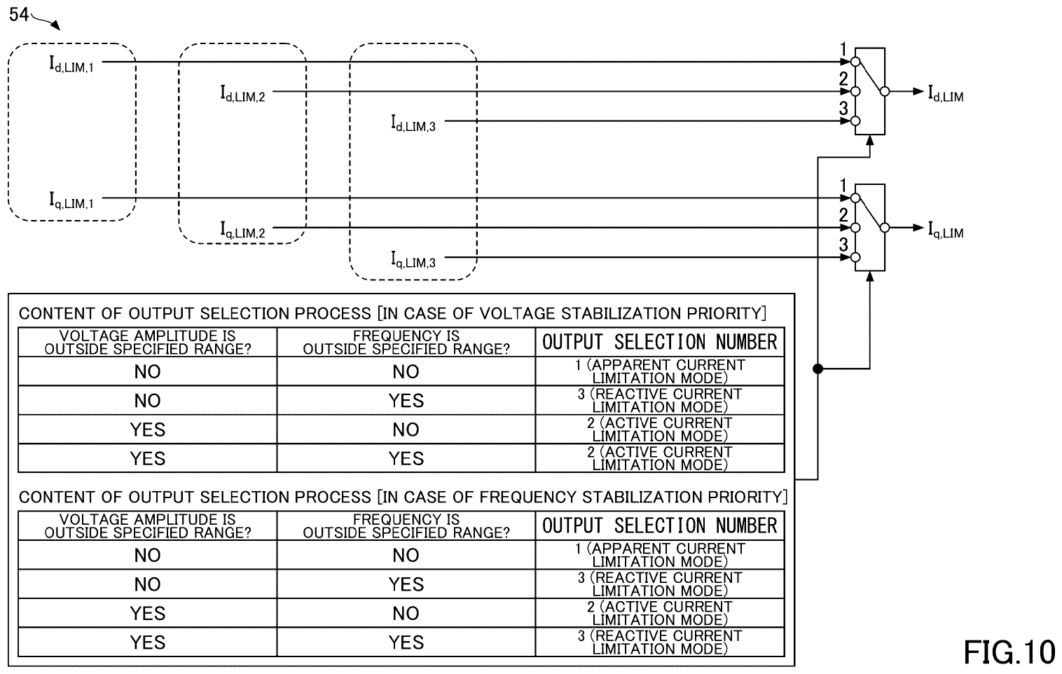

FIG. 10 is a functional block diagram illustrating an example of the mode selector. The mode selector 54 illustrated in FIG. 10 is an example of the mode selector 54 illustrated in FIG. 3. The mode selector 54 is configured to switch the current limitation mode (the apparent current limitation mode, the active current limitation mode, and the reactive current limitation mode) manually or automatically.

The mode selector 54 is configured to select the apparent current limitation mode in a case where the amplitude of the output voltage from the inverter 5 is detected as not being outside a predetermined amplitude range and the frequency of the output voltage from the inverter 5 is detected as not being outside a predetermined frequency range. In this case, the mode selector 54 is configured to output the d-axis current command limit value I_{d,LIM,1} as the d-axis current limit value I_{d,LIM}, and output the q-axis current command limit value I_{q,LIM,1} as the q-axis current limit value I_{q,LIM}. Hence, the active current and the reactive current are reduced by identical gains, so that the apparent current becomes less than or equal to the limit value, thereby suppressing the overcurrent.

The mode selector 54 is configured to select the reactive current limitation mode in a case where the amplitude of the output voltage from the inverter 5 is detected as not being out of the predetermined amplitude range and the frequency of the output voltage from the inverter 5 is detected as being out of the predetermined frequency range. In this case, the mode selector 54 is configured to output the d-axis current command limit value I_{d,LIM,3} as the d-axis current limit value I_{d,LIM}, and output the q-axis current command limit value I_{q,LIM,3} as the q-axis current limit value I_{q,LIM}. Hence, the reactive current decreases with a gain greater than that of the active current so that the apparent current becomes less than or equal to the limit value, and thus, the frequency of the power system 1 can be stabilized by the output of the active current while suppressing the overcurrent.

The mode selector 54 is configured to select the active current limitation mode in a case where the amplitude of the output voltage from the inverter 5 is detected as being out of the predetermined amplitude range and the frequency of the output voltage from the inverter 5 is detected as not being out of the predetermined frequency range. In this case, the mode selector 54 is configured to output the d-axis current command limit value I_{d,LIM,2} as the d-axis current limit value I_{d,LIM}, and output the q-axis current command limit value I_{q,LIM,2} as the q-axis current limit value I_{q,LIM}. Hence, the active current decreases with a gain greater than that of the reactive current so that the apparent current becomes less than or equal to the limit value, and thus, the voltage of the power system 1 can be stabilized by the output of the reactive current while suppressing the overcurrent.

The mode selector 54 is configured to select the active current limitation mode or the reactive current limitation mode in a case where the amplitude of the output voltage from the inverter 5 is detected as being out of the predetermined amplitude range and the frequency of the output voltage from the inverter 5 is detected as being out of the predetermined frequency range.

The mode selector 54 is configured to select one of the active current and the reactive current, which is to be limited with priority over the other, according to an external signal from outside the control device 20. In a case where the external signal is a signal that prioritizes the voltage stabilization of the power system 1, the mode selector 54 is configured to select the current limitation mode based on an upper table illustrated in FIG. 10, in order to prioritize limiting the active current over the reactive current. In this case, the mode selector 54 is configured to select the active current limitation mode in a case where the amplitude of the output voltage from the inverter 5 is detected as being out of the predetermined amplitude range and the frequency of the output voltage from the inverter 5 is detected as being out of the predetermined frequency range. On the other hand, in a case where the external signal is a signal that prioritizes the frequency stabilization of the power system 1, the mode selector 54 is configured to select the current limitation mode based on a lower table illustrated in FIG. 10, in order to prioritize limiting the reactive current over the active current. In this case, the mode selector 54 is configured to select the reactive current limitation mode in a case where the amplitude of the output voltage from the inverter 5 is detected as being out of the predetermined amplitude range and the frequency of the output voltage from the inverter 5 is detected as being out of the predetermined frequency range.

For example, in a case where the amplitude of the output voltage from the inverter 5 is outside the predetermined amplitude range, the mode selector 54 may determine that the amplitude of the output voltage from the inverter 5 is disturbed, and in this case, the mode selector 54 may determine that a voltage disturbance of the power system 1 occurred. The method of determining the occurrence of the voltage disturbance is not limited to this method.

For example, in a case where the frequency of the output voltage from the inverter 5 is outside the predetermined frequency range, the mode selector 54 may determine that the frequency of the output voltage from the inverter 5 is disturbed, and in this case, the mode selector 54 may determine that a frequency disturbance of the power system 1 occurred. The method of determining the occurrence of the frequency disturbance is not limited to this method.

In FIG. 3, the current command limitation unit is configured to calculate an absolute value of the d-axis current limit value I_{d,LIM} selected by the mode selector 54, sets a value obtained by adding a positive sign to the absolute value as a d-axis upper limit value, and sets a value obtained by adding a negative sign to the absolute value as a d-axis lower limit value. The current command limitation unit 40 is configured to limit the d-axis current command value i_{d,ref} to a value greater than or equal to the d-axis lower limit value and less than or equal to the d-axis upper limit value, and outputs the limited value as the d-axis current command value i_{d,ref,LIM}. Similarly, the current command limitation unit 40 is configured to calculate an absolute value of the q-axis current limit value I_{q,LIM} selected by the mode selector 54, sets a value obtained by adding a positive sign to the absolute value as a q-axis upper limit value, and sets a value obtained by adding a negative sign to the absolute value as a q-axis lower limit value. The current command limitation unit is configured to limit the q-axis current command value i_{q,ref} to a value greater than or equal to the q-axis lower limit value and less than or equal to the q-axis upper limit value, and outputs the limited value as the q-axis current command value i_{q,ref,LIM}.

Hence, according to the first embodiment, the control device 20A includes the current command limitation unit 40 configured to prioritize limiting one of the active current and the reactive current output from the inverters 5 over the other of the active current and the reactive current, so that the apparent current output from the inverters 5 becomes less than or equal to the limit value. Thus, the frequency or the voltage of the power system 1 can be stabilized while suppressing the overcurrent.

### Second Embodiment

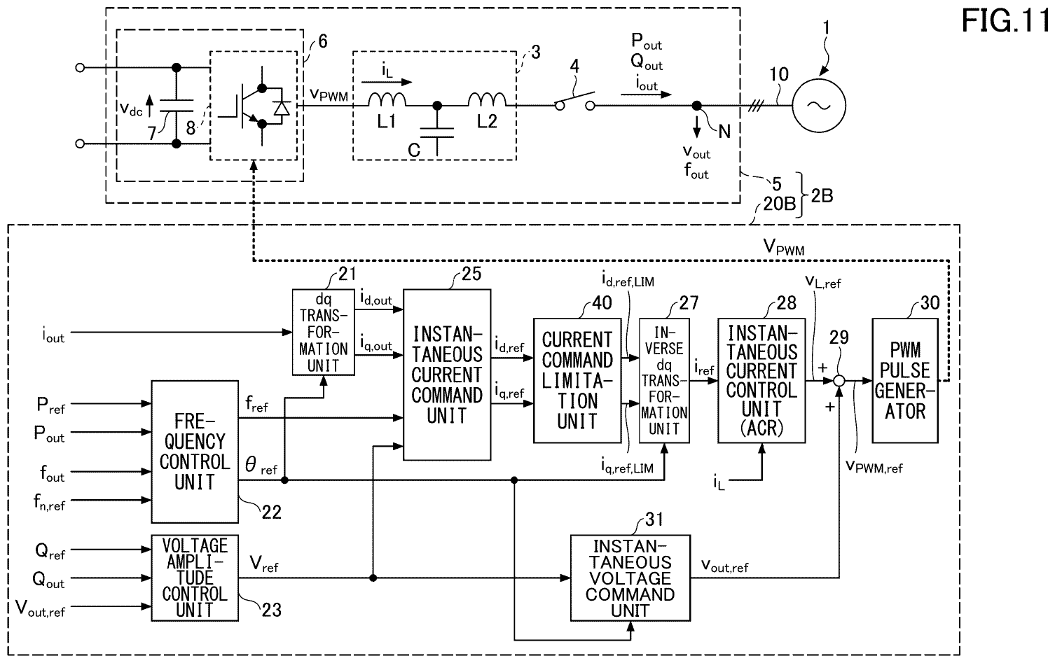

FIG. 11 is a diagram illustrating configuration examples of the inverter and the control device in the electric power conversion apparatus according to a second embodiment. In the second embodiment, a description of the same configuration, operation, and effect as those of the first embodiment will be omitted by incorporating the above description of the first embodiment. FIG. 11 illustrates a circuit configuration of the inverter 5 and a functional block diagram of a control device 20B. An electric power conversion apparatus 2B according to the second embodiment is an example of the electric power conversion apparatus 2. The electric power conversion apparatus 2B includes the inverter 5, and the control device 20B.

The control device 20B is configured to control the inverter 5 according to a voltage control method. The control device 20B includes a frequency control unit 22, a voltage amplitude control unit 23, an instantaneous voltage command unit 31, a dq transformation unit 21, an instantaneous current command unit 25, an inverse dq transformation unit 27, an instantaneous current control unit 28, an adder 29, and a PWM pulse generator 30.

### [Frequency Control Unit]

The frequency control unit 22 is configured to control the frequency of the voltage V_{PWM} output from the inverter circuit 8. The frequency control unit 22 is configured to perform a frequency control, that is, a frequency synchronization control, to control the frequency of the voltage V_{PWM} output from the inverter circuit 8 to approach the frequency of the output voltage Vₒᵤₜ output from the inverter 5 to the power system 1. The frequency control unit 22 is configured to derive a frequency command value f_{ref}, which is a command value of the frequency of the voltage V_{PWM} output from the inverter circuit 8, and a phase command value θ_{ref}, which is a command value of a phase of the voltage V_{PWM} output from the inverter circuit 8.

The frequency control unit 22 is configured to calculate and output the frequency command value f_{ref} and the phase command value θ_{ref} based on the active power command value P_{ref}, the active power measurement value Pₒᵤₜ, the frequency measurement value fₒᵤₜ, and the rated frequency setting value f_{n,ref}, for example.

The active power command value P_{ref} is a command value of the active power output from the inverter 5 to the power system 1. The active power measurement value Pₒᵤₜ is a measurement value of the active power actually output from the inverter 5 to the power system 1. The active power measurement value Pₒᵤₜ is a measurement value at the node N between the filter 3 and the power system 1.

The frequency measurement value fₒᵤₜ is a measurement value of the frequency of the output voltage Vₒᵤₜ actually output from the inverter 5 to the power system 1. The frequency measurement value fₒᵤₜ is the measurement value at the node N between the filter 3 and the power system 1.

The rated frequency setting value f_{n,ref} is a setting value of the rated frequency of the power system 1. For example, the rated frequency setting value f_{n,ref} of 50 Hz is adopted in Eastern Japan, and the rated frequency setting value f_{n,ref} of 60 Hz is adopted Western Japan.

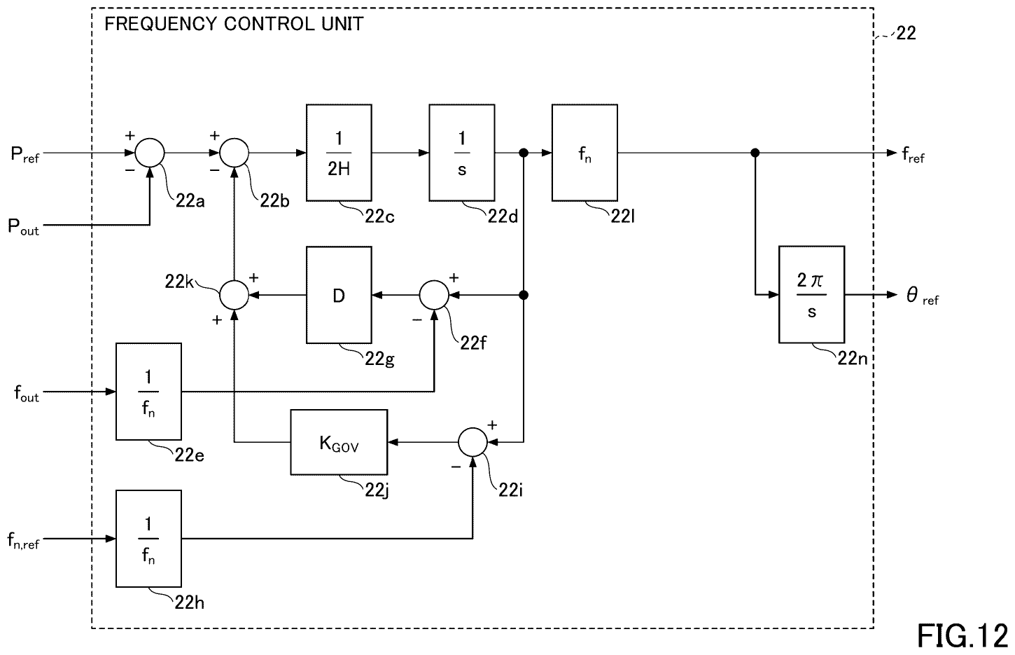

FIG. 12 is a functional block diagram illustrating an example of the frequency control unit in the control device. The frequency control unit 22 illustrated in FIG. 12 is a section configured to perform a frequency control of a GEM control. The frequency control unit 22 includes adders 22a, 22b, 22f, 22i, and 22k, multipliers 22c, 22e, 22g, 22h, 22j, and 22l, and integration units 22d and 22n.

In the following description, a unit inertia constant and the unit damping constant in a case where the inverter 5 operates as a virtual synchronous generator are denoted by H and D, respectively.

The adder 22a is configured to output a value (P_{ref}−Pₒᵤₜ) obtained by subtracting the active power measurement value Pₒᵤₜ from the active power command value P_{ref} to the adder 22b.

The adder 22b is configured to output a value obtained by subtracting an input from the adder 22k from the input value (P_{ref}-Pₒᵤₜ) from the adder 22a to the multiplier 22c.

The multiplier 22c is configured to output a value obtained by multiplying a value 1/(2H) to the input value from the adder 22b to the integration unit 22d (H denotes the unit inertia constant).

The integration unit 22d is configured to output a result of integrating the input value from the multiplier 22c to the multiplier 22l.

The multiplier 22e is configured to output a value obtained by dividing the frequency measurement value fₒᵤₜ of the output voltage Vₒᵤₜ by the rated frequency setting value fₙ of the inverter 5 to the adder 22f. An output of the multiplier 22e is the frequency measurement value fₒᵤₜ of the output voltage Vₒᵤₜ normalized by the rated frequency setting value fₙ.

The adder 22f is configured to output a value obtained by subtracting the input value from the multiplier 22e from the input value from the integration unit 22d to the multiplier 22g.

The multiplier 22g is configured to output a value obtained by multiplying the unit damping constant D to the input value from the adder 22f to the adder 22k.

The multiplier 22h is configured to output a value obtained by dividing the rated frequency setting value f_{n,ref} of the power system 1 by the rated frequency setting value fₙ of the inverter 5 to the adder 22i. An output of the multiplier 22h is the rated frequency setting value f_{n,ref} of the power system 1 normalized by the rated frequency setting value fₙ.

The adder 22i is configured to output a value obtained by subtracting the input value from the multiplier 22h from the input value from the integration unit 22d to the multiplier 22j.

The multiplier 22j is configured to output a value obtained by multiplying a gain Krov to the input value from the adder 22i to the adder 22k. The gain KGov is a high-speed governor gain, which is one of parameters for adjusting a rotation speed of a rotor to maintain the rated frequency setting value f_{n,ref} of the power system 1.

The adder 22k is configured to output a value obtained by adding the input value from the multiplier 22g and the input value from the multiplier 22j to the adder 22b.

The multiplier 22l is configured to output a value obtained by multiplying the rated frequency setting value fₙ of the inverter 5 to the input value from the integration unit 22d. The output value of the multiplier 22l corresponds to the frequency command value f_{ref} for controlling the frequency of the voltage V_{PWM} output from the inverter circuit 8, so as to control the frequency of the output voltage Vₒᵤₜ output from the inverter 5 to the power system 1.

The integration unit 22n is configured to perform an operation of integrating a value obtained by multiplying 21 to the input value from the multiplier 22l. The integration unit 22n is configured to output the phase command value θ_{ref} by this operation.

### [Voltage Amplitude Control Unit]

In FIG. 11, the voltage amplitude control unit 23 is configured to control an amplitude of the voltage V_{PWM} output from the inverter circuit 8. The amplitude of the voltage V_{PWM} refers to an amplitude of a waveform formed by components (components excluding components derived from a modulating wave used for the pulse width modulation) in a vicinity of a fundamental wave included in the voltage V_{PWM}. The voltage amplitude control unit 23 is configured to perform a voltage amplitude control to control the amplitude of the voltage V_{PWM} output from the inverter circuit 8 to approach the amplitude of the output voltage Vₒᵤₜ output from the inverter 5 to the power system 1. The voltage amplitude control unit 23 is configured to derive an amplitude command value Vref, which is a command value of the amplitude of the voltage V_{PWM} output from the inverter circuit 8.

The voltage amplitude control unit 23 is configured to calculate and output the amplitude command value Vref, based on the reactive power command value Q_{ref}, the reactive power measurement value Cout, and the output voltage amplitude command value V_{out,ref}, for example.

The reactive power command value Q_{ref} is a command value of the reactive power output from the inverter 5 to the power system 1. The reactive power measurement value Qₒᵤₜ is a measurement value of the reactive power actually output from the inverter 5 to the power system 1. The reactive power measurement value Qₒᵤₜ is a measurement value at the node N between the filter 3 and the power system 1.

The output voltage amplitude command value V_{out,ref} is a command value of the amplitude of the output voltage Vₒᵤₜ output from the inverter 5 to the power system 1.

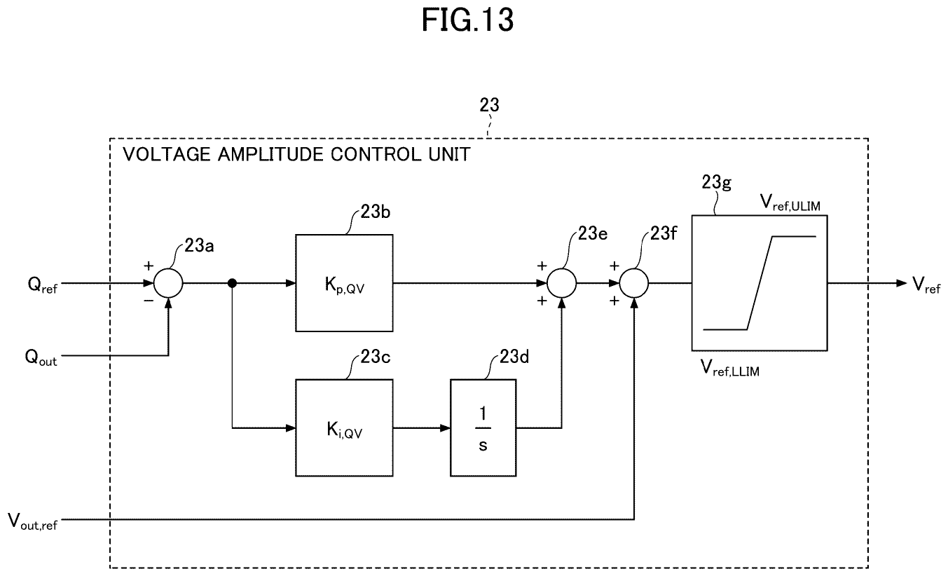

FIG. 13 is a functional block diagram illustrating an example of the voltage amplitude control unit in the control device. The voltage amplitude control unit 23 illustrated in FIG. 13 is a section configured to perform a voltage amplitude control of a GFM control. The voltage amplitude control unit 23 includes adders 23a, 23e, and 23f, multipliers 23b and 23c, an integration unit 23d, and a limitation unit 23g.

The adder 23a is configured to output a value obtained by subtracting the reactive power measurement value Qₒᵤₜ from the reactive power command value Q_{ref} to the multiplier 23b and the multiplier 23c.

The multiplier 23b is configured to output a value obtained by multiplying a gain K_{p,QV} to the input value from the adder 23a to the adder 23e. The gain K_{p,QV} is a parameter for performing a proportional control so as to reduce a difference between the reactive power measurement value Qₒᵤₜ and the reactive power command value Q_{ref}. The gain K_{p,QV} is a proportional gain of a proportional-integral controller (PI controller) for Q-V droop control, for example.

The multiplier 23c is configured to output a value obtained by multiplying a gain K_{i,QV} to the input value from the adder 23a to the integration unit 23d. The gain K_{i,QV} is a parameter for performing an integral control so as to reduce the difference between the reactive power measurement value Qₒᵤₜ and the reactive power command value Q_{ref}. The gain K_{i,QV} is an integral gain of a proportional-integral controller (PI controller) for Q-V droop control, for example.

The integration unit 23d is configured to output a result of a time integration of the input value from the multiplier 23c to the adder 23e.

The adder 23e is configured to output a value obtained by adding the input value from the multiplier 23b and the input value from the integration unit 23d to the adder 23f.

The adder 23f is configured to output a value obtained by adding the input value from the adder 23e and an amplitude command value V_{out,ref} of the output voltage Vₒᵤₜ to the limitation unit 23g.

The limitation unit 23g is configured to limit the input value from the adder 23f based on a set upper limit value and a set lower limit value, and output the limited value as the amplitude command value Vref.

The limitation unit 23g is configured to output the input value from the adder 23f as it is in a case where the input value from the adder 23f is greater than or equal to a lower limit value V_{ref,LLIM} and less than or equal to an upper limit value V_{ref,ULIM}.

The limitation unit 23g is configured to output the upper limit value V_{ref,ULIM} in a case where the input value from the adder 23f is greater than the upper limit value V_{ref,ULIM}. The limitation unit 23g is configured to output the lower limit value V_{ref,LLIM} in a case where the input value from the adder 23f is less than the lower limit value V_{ref,LLIM}.

An output value of the limitation unit 23g corresponds to the amplitude command value Vref for controlling the amplitude of the voltage V_{PWM} output from the inverter circuit 8, so as to control the amplitude of the output voltage Vₒᵤₜ output from the inverter 5 to the power system 1.

### [Instantaneous Voltage Command Unit]

In FIG. 11, the instantaneous voltage command unit 31 is configured to derive an output voltage command value V_{out,ref}, which is a command value of the three-phase output voltage output from the inverter 5 to the power system 1, based on the amplitude command value Vref and the phase command value θ_{ref}. The output voltage command value V_{out,ref} is a command value of a three-phase instantaneous voltage output from the inverter 5 to the power system 1.

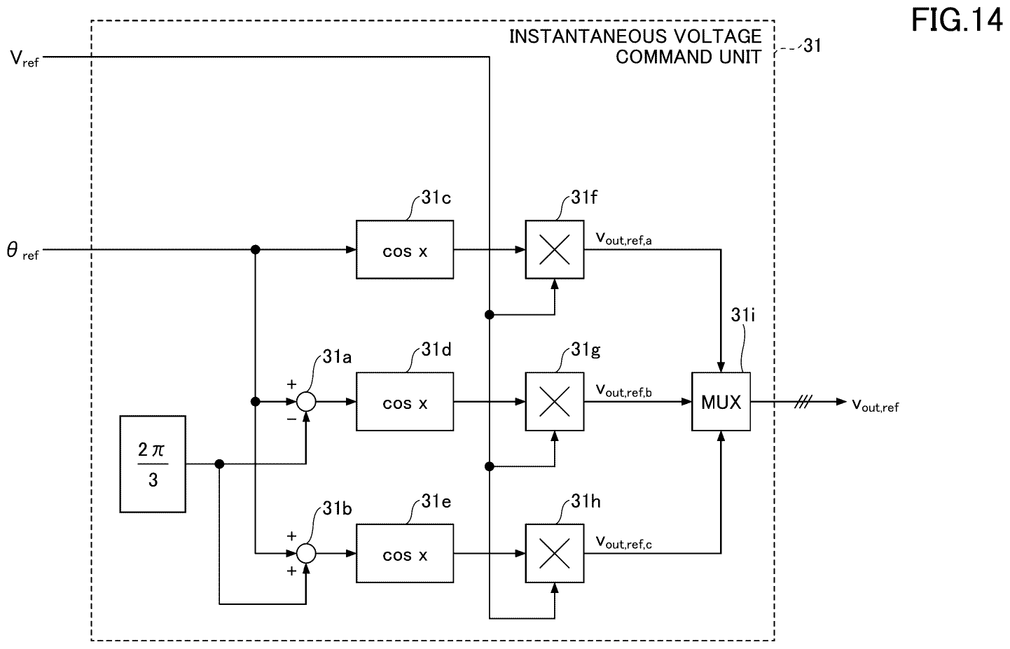

FIG. 14 is a functional block diagram illustrating an example of the instantaneous voltage command unit in the control device. The instantaneous voltage command unit 31 illustrated in FIG. 14 is a section configured to perform an instantaneous voltage command calculation process of a GEM control. The instantaneous voltage command unit 31 includes adders 31a and 31b, cosine functions 31c, 31d, and 31e, multipliers 31f, 31g, and 31h, and a multiplexer 31i.

The adder 31a is configured to output a value (θ_{ref}−(2π/3)) obtained by subtracting (2π/3) from the phase command value θ_{ref} to the cosine function 31d.

The adder 31b is configured to output a value (θ_{ref}+ (2π/3)) obtained by adding the phase command value θ_{ref} and (2π/3) to the cosine function 31e.

The multiplier 31f is configured to multiply the amplitude command value Vref to the input value cos (θ_{ref}) from the cosine function 31c, and output the multiplied value as an output voltage command value V_{out,ref,a} of an A-phase.

The multiplier 31g is configured to multiply the reference value Vref to the input value cos (θ_{ref}−(2π/3)) from the cosine function 31d, and output the multiplied value as an output voltage command value V_{out,ref,b} of a B-phase.

The multiplier 31h is configured to multiply the reference value Vref to the input value cos (θ_{ref}+(2π/3)) from the cosine function 31e, and output the multiplied value as an output voltage command value V_{out,ref,c} of a C-phase.

The multiplexer 31i is configured to combine the output voltage command values V_{out,ref,a}/V_{out,ref,b}, and V_{out,ref,c} of the respective phases into one signal, and output the three-phase output voltage command value V_{out,ref} to be output from the inverter 5 to the power system 1. In this example, the three signals are combined into one signal by the multiplexer 31i in order to facilitate processing of the three signals, but the signals may be sent to a next block as three separate signals without using the multiplexer 31i.

### [dq Transformation Unit]

In FIG. 11, the dq transformation unit 21 is configured to perform a dq transformation of an output current measurement value iₒᵤₜ, which is a measurement value of the three-phase output current output from the inverter 5 to the power system 1, into a two-axis current (a d-axis current i_{d,out} and a q-axis current i_{q,out}) using the phase command value θ_{ref}, and output the two-axis current. The output current measurement value iₒᵤₜ is a measurement value of an output current actually output from the inverter 5 to the power system 1.

The d-axis current i_{d,out} is an active current component that contributes to an active power output from the inverter 5 to the power system 1. The q-axis current i_{q,out} is a reactive current component that contributes to a reactive power output from the inverter to the power system 1. The d-axis current i_{d,out} and the q-axis current i_{q,out} are a d-axis component and a q-axis component, respectively, in a rotating coordinate system that rotates at an angular frequency corresponding to the frequency command value f_{ref} (a command value of the frequency of the voltage V_{PWM} output from the inverter circuit 8) derived by the frequency control unit 22.

### [Instantaneous Current Command Unit]

In FIG. 11, the instantaneous current command unit 25 derives the d-axis current command value i_{d,ref} and the q-axis current command value i_{q,ref}, based on the d-axis current i_{d,out}, the q-axis current i_{q,out}, the frequency command value f_{ref}, and the amplitude command value Vref. The d-axis current command value i_{d,ref} and the q-axis current command value i_{q,ref} are the two-axis command value of the current i_{L} output from the inverter circuit 8 to the filter 3. The d-axis current command value i_{d,ref} is an example of a first current command value, and because the current it does not deviate significantly from the output current iₒᵤₜ from the inverter 5 to the power system 1, the d-axis current command value i_{d,ref} contributes to the active power output from the inverter 5 to the power system 1. The q-axis current command value I_{q,ref} is an example of a second current command value, and because the current I_{L} does not deviate significantly from the output current iₒᵤₜ from the inverter 5 to the power system 1, the q-axis current command value I_{q,ref} contributes to the reactive power output from the inverter 5 to the power system 1.

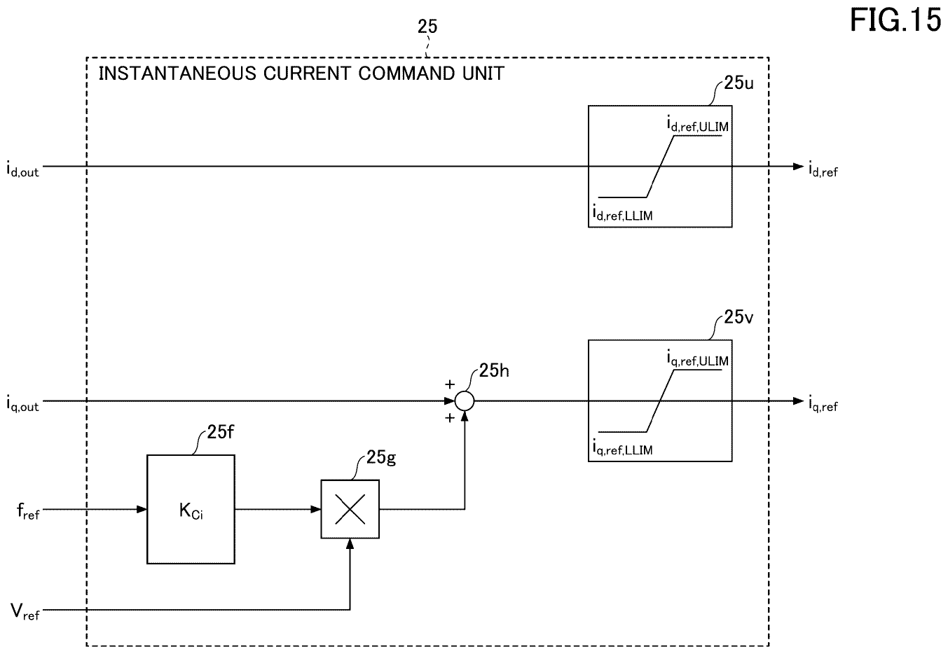

FIG. 15 is a functional block diagram illustrating an example of the instantaneous current command unit in the control device. The instantaneous current command unit 25 illustrated in FIG. 15 is a section configured to performs a instantaneous current command value calculation process of a GEM control. The instantaneous current command unit 25 includes a multiplier 25f, a multiplier 25g, an adder 25h, a limitation unit 25u, and a limitation unit 25v.

The limitation unit 25u is configured to limit the d-axis current i_{d,out} from the dq transformation unit 21 based on a set upper limit value and a set lower limit value, and output the limited value as the d-axis current command value i_{d,ref}.

The limitation unit 25u is configured to output the d-axis current i_{d,out} from the dq transformation unit 21 as it is, in a case where the d-axis current i_{d,out} from the dq transformation unit 21 is greater than or equal to a lower limit value i_{d,ref,LLIM} and less than or equal to an upper limit value i_{d,ref,ULIM}. The limitation unit 25u is configured to output the upper limit value i_{d,ref,ULIM} in a case where the d-axis current i_{d,out} from the dq transformation unit 21 is greater than the upper limit value i_{d,ref,ULIM}. The limitation unit 25u is configured to output the lower limit value i_{d,ref,LLIM} in a case where the d-axis current i_{d,out} from the dq transformation unit 21 is less than the lower limit value i_{d,ref,LLIM}.

The multiplier 25f is configured to output a value obtained by multiplying a gain K_{Ci} to the frequency command value f_{ref} from the frequency control unit 22 to the multiplier 25g. The gain K_{Ci} is a coefficient for calculating a current flowing through the capacitor C of the filter 3.

The multiplier 25g is configured to output a value obtained by multiplying the input value from the multiplier 25f by the voltage command value V_{ref} from the voltage amplitude control unit 23 to the adder 25h.

The adder 25h is configured to output a value obtained by adding the q-axis current I_{q,out} from the dq transformation unit 21 and the input value from the multiplier 25g to the limitation unit 25v.

The limitation unit 25v is configured to limit the input value from the adder 25h based on a set upper limit value and a set lower limit value, and output the limited value as the q-axis current command value i_{q,ref}.

The limitation unit 25v is configured to output the input value from the adder 25h as it is, in a case where the input value from the adder 25h is greater than or equal to a lower limit value i_{q,ref,LLIM} and less than or equal to an upper limit value i_{q,ref,ULIM}.

The limitation unit 25v is configured to output the upper limit i_{q,ref,ULIM} in a case where the input value from the adder 25h is greater than the upper limit i_{q,ref,ULIM}. The limitation unit 25v is configured to output the lower limit i_{q,ref,LLIM} in a case where the input value from the adder 25h is less than the lower limit i_{q,ref,LLIM}.

### [Current Command Limitation Unit]

In FIG. 11, the current command limitation unit 40 is configured to generate a d-axis current command value i_{d,ref,LIM}, Which is the limited d-axis current command value i_{d,ref}, and generate a q-axis current command value i_{q,ref,LIM}, which is the limited q-axis current command value i_{q,ref}, in order to suppress an overcurrent flowing in the power system 1. The current command limitation unit 40 of the second embodiment may have the same configuration as the current command limitation unit 40 of the first embodiment.

### [Inverse dq Transformation Unit]

In FIG. 11, the inverse dq transformation unit 27 is configured to perform an inverse dq transformation of the two-axis current command value (the d-axis current command value i_{d,ref,LIM} and the q-axis current command value i_{q,ref,LIM}) into the three phase output current command value i_{ref}, and output the output current command value i_{ref}. The output current command value i_{ref} is the three phase command value of the current i_{L} output from the inverter circuit 8 to the filter 3.

### [Instantaneous Current Control Unit]

In FIG. 11, the instantaneous current control unit 28 is configured to control the current i_{L} output from the inverter circuit 8 to the filter 3. The instantaneous current control unit 28 is configured to perform an instantaneous current control to control the current i_{L} output from the inverter circuit 8 to the filter 3 to approach the output current command value i_{ref}. The instantaneous current control unit 28 may be configured as an Automatic Current Regulator (ACR), for example, which samples the current i_{L} as an instantaneous current and performs a feedback control so that the current measurement value i_{L} which is the sampled value, matches the output current command value i_{ref}. The current measurement value i_{L} is a measurement value of the three-phase instantaneous current flowing from the inverter circuit 8 to the reactor L1 of the filter 3.

The instantaneous current control unit 28 is configured to generate the output voltage correction value V_{L,ref}, based on the output current command value i_{ref} and the current measurement value is so that the current measurement value i_{L} approaches the output current command value i_{ref}. The output voltage correction value V_{L,ref} is added to the output voltage command value V_{out,ref} by the adder 29, in order to correct the output voltage command value V_{out,ref}, which is a command value of the three-phase output voltage output from the inverter 5 to the power system 1.

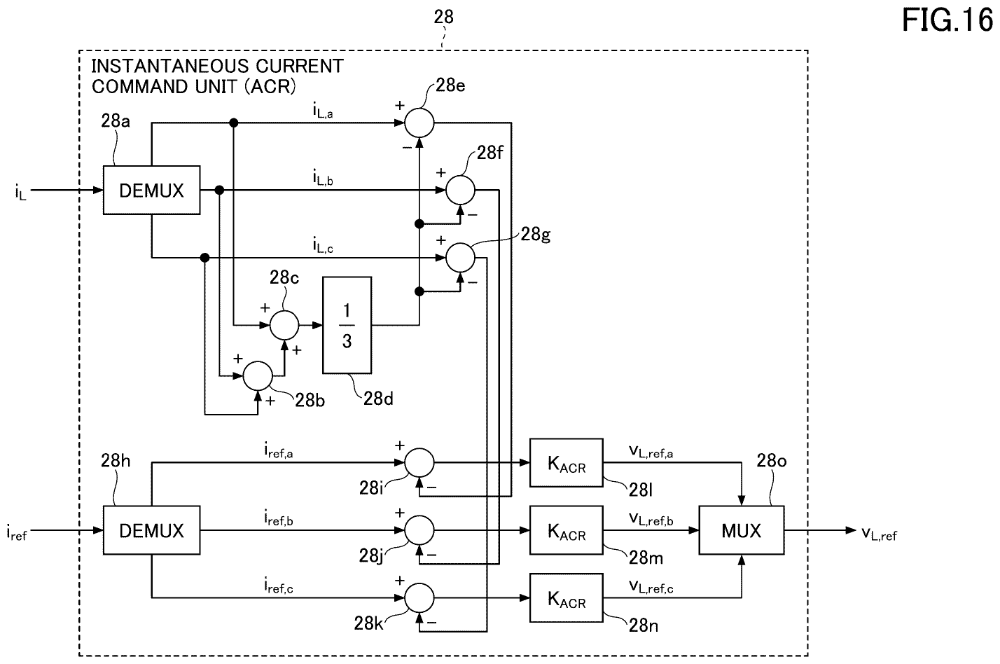

FIG. 16 is a functional block diagram illustrating an example of the instantaneous current control unit in the control device. The instantaneous current control unit 28 illustrated in FIG. 16 is a section configured to perform an instantaneous current control of a GEM control. The instantaneous current control unit 28 includes demultiplexers 28a and 28h, adders 28b, 28c, 28e, 28f, 28g, 28i, 28j, and 28k, multipliers 28d, 28l, 28m, and 28n, and a multiplexer 280.

The demultiplexer 28a is configured to expand the current measurement value it, which is a measurement value of a filter current flowing from the power converter 6 to the filter 3, into a current measurement value i_{L,a} of the A-phase, a current measurement value i_{L,b} of the B-phase, and a current measurement value i_{L,c} of the C-phase. Although the signals of the respective phases are combined and the signals are expanded by the demultiplexer 28a in this example in order to facilitate processing of the signals of it, the signals of it may be processed as three separate signals without being combined, and in this latter case, the demultiplexer 28a may be omitted.

The adder 28b and the adder 28c are configured to output a value obtained by adding the three-phase current measurement values i_{L,a}, i_{L,b}, and i_{L,c} to the multiplier 28d.

The multiplier 28d is configured to output a value obtained by dividing a value obtained by adding the three-phase current measurement values i_{L,a}, i_{L,b}, and i_{L,c} by 3 to the adders 28e, 28f, and 28g.

The adder 28e is configured to output a value obtained by subtracting the input value from the multiplier 28d from the current measurement value i_{L,a} of the A-phase to the adder 28i. The adder 28f is configured to output a value obtained by subtracting the input value from the multiplier 28d from the current measurement value i_{L,b} of the B-phase to the adder 28j. The adder 28g is configured to output a value obtained by subtracting the input value from the multiplier 28d from the current measurement value i_{L,c} of the C-phase to the adder 28k.

The demultiplexer 28h is configured to expand the output current command value i_{ref}, which is the three-phase command value of the current i_{L} output from the inverter circuit 8 to the filter 3, into an output current command value i_{ref,a} of the A-phase, an output current command value i_{ref,b} of the B-phase, and an output current command value i_{ref,c} of the C-phase.

The adder 28i is configured to output a value obtained by subtracting the input value from the adder 28e from the output current command value i_{ref,a} of the A-phase to the multiplier 28l. The adder 28j is configured to output a value obtained by subtracting the input value from the adder 28f from the output current command value i_{ref,b} of the B-phase to the multiplier 28m. The adder 28k is configured to output a value obtained by subtracting the input value from the adder 28g from the output current command value i_{ref,c} of the C-phase to the multiplier 28n.

The multiplier 28l is configured to output a value obtained by multiplying a gain K_{ACR} to the input value from the adder 28i to the multiplexer 280, as an output voltage correction value V_{L,ref,a} of the A-phase. The multiplier 28m is configured to output a value obtained by multiplying the gain K_{ACR} to the input value from the adder 28j to the multiplexer 280, as an output voltage correction value V_{L,ref,b} of the B-phase. The multiplier 28n is configured to output a value obtained by multiplying the gain K_{ACR} to the input value from the adder 28k to the multiplexer 280, as an output voltage correction value V_{L,ref,c} of the C-phase. The gain K_{ACR} is a parameter for performing a control to reduce a difference between the current measurement value i and the output current command value i_{ref}. The gain K_{ACR} is a Proportional gain (P gain) in a case where the ACR control is performed by a P controller, for example.

The multiplexer 280 is configured to combine the output voltage correction values V_{L,ref,a}, V_{L,ref,b}, and V_{L,ref,c} of the respective phases, which are inputs from the multipliers 28l, 28m, and 28n, into one signal, and output the output voltage correction value V_{L,ref} of the three phases. Similar to the case described above, it is possible to adopt a configuration in which the multiplexer is omitted.

### [Adder]

In FIG. 11, the adder 29 is configured to output a value obtained by adding the output voltage correction value V_{L,ref} to the output voltage command value V_{out,ref}, and output the value as the PWM command value V_{PWM,ref}.

### [PWM Pulse Generator]

In FIG. 11, the PWM pulse generator 30 is configured to compare the PWM command value V_{PWM,ref} with a carrier signal, such as a triangular wave or the like, and generate the PWM pulse signal V_{PWM} including the PWM pulse. The pulse width modulation method is not limited to the triangular wave comparison modulation method, and a generally used pulse width modulation method may be utilized. Of course, a required number of PWM pulses needs to be generated depending on the configuration of the inverter circuit 8.

Hence, according to the second embodiment, the control device 20B includes the current command limitation unit 40 configured to prioritize limiting one of the active current and the reactive current output from the inverter 5 over the other of the active current and the reactive current, so that the apparent current output from the inverter 5 becomes less than or equal to the limit value. Thus, the frequency or voltage of the power system 1 can be stabilized while suppressing the overcurrent.

According to the present disclosure, it is possible to stabilize the frequency or voltage of the system while suppressing the overcurrent.

Although the embodiments are described above in detail, the embodiments are presented as examples, and the present invention is not limited to the described embodiments. The embodiments described above can be implemented in various other forms, and various combinations, omissions, substitutions, modifications, or the like can be made without departing from the scope of the present invention. The embodiments and modifications thereof are included in the scope of the present invention, and are included in the present invention recited in the claims and the scope of equivalents thereof.

What is claimed is:

1. An electric power conversion apparatus comprising:
an inverter configured to convert input DC power into AC power; and
a control device configured to control the inverter,
wherein the control device is configured to prioritize limiting one of an active current and a reactive current output from the inverter over the other of the active current and the reactive current, so that an apparent current output from the inverter becomes less than or equal to a limit value.

2. The electric power conversion apparatus as claimed in claim 1, wherein the control device is configured to prioritize limiting the active current over the reactive current, so that the apparent current becomes less than or equal to the limit value in a case where a disturbance occurs in an amplitude of an output voltage from the inverter.

3. The electric power conversion apparatus as claimed in claim 1, wherein the control device is configured to prioritize limiting the active current over the reactive current, so that the apparent current becomes less than or equal to the limit value in a case where an amplitude of an output voltage from the inverter is outside a predetermined amplitude range.

4. The electric power conversion apparatus as claimed in claim 1, wherein the control device is configured to reduces the active current with a gain greater than that of the reactive current, so that the apparent current becomes less than or equal to the limit value in a case where a disturbance occurs in an amplitude of an output voltage from the inverter.

5. The electric power conversion apparatus as claimed in claim 1, wherein the control device is configured to prioritize limiting the reactive current over the active current, so that the apparent current becomes less than or equal to the limit value in a case where a disturbance occurs in a frequency of an output voltage from the inverter.

6. The electric power conversion apparatus as claimed in claim 1, wherein the control device is configured to prioritize limiting the reactive current over the active current, so that the apparent current becomes less than or equal to the limit value in a case where a frequency of an output voltage from the inverter is outside a predetermined frequency range.

7. The electric power conversion apparatus as claimed in claim 1, wherein the control device is configured to reduce the reactive current with a gain greater than that of the active current, so that the apparent current becomes less than or equal to the limit value in a case where a disturbance occurs in a frequency of an output voltage from the inverter.

8. The electric power conversion apparatus as claimed in claim 1, wherein the control device is configured to:
prioritize limiting the active current over the reactive current, so that the apparent current becomes less than or equal to the limit value in a case where a disturbance occurs in an amplitude of an output voltage from the inverter, and
prioritize limiting the reactive current over the active current, so that the apparent current becomes less than or equal to the limit value in a case where a disturbance occurs in a frequency of an output voltage from the inverter.

9. The electric power conversion apparatus as claimed in claim 1, wherein the control device is configured to select which of the active current and the reactive current is to be prioritized of the limiting, according to an external signal from outside the control device.

10. The electric power conversion apparatus as claimed in claim 9, wherein the control device is configured to select which of the active current and the reactive current is to be prioritized of the limiting, according to the external signal from the outside in a case where a disturbance occurs in an amplitude of an output voltage from the inverter and a disturbance occurs in a frequency of the output voltage from the inverter.

11. An electric power conversion apparatus comprising:
an inverter configured to convert input DC power into AC power; and
a control device configured to control the inverter,
wherein the control device is configured to reduce one of an active current and a reactive current output from the inverter with a gain greater than that of the other of the active current and the reactive current, so that an apparent current output from the inverter becomes less than or equal to a limit value.

12. The electric power conversion apparatus as claimed in claim 11, wherein the control device is configured to select whether to reduce the one of the active current and the reactive current with the gain greater than that of the other of the active current and the reactive current, or to reduce the one of the active current and the reactive current and the other of the active current and the reactive current with identical gains, so that the apparent current becomes less than or equal to the limit value.

13. The electric power conversion apparatus as claimed in claim 11, wherein the control device is configured to select whether to reduce the active current with a gain greater than that of the reactive current, or to reduce the reactive current with a gain greater than that of the active current, so that the apparent current becomes less than or equal to the limit value.

14. The electric power conversion apparatus as claimed in claim 11, wherein the control device is configured to select whether to reduce the active current and the reactive current with identical gains, or to reduce the active current with a gain greater than that of the reactive current, or to reduce the reactive current by a gain greater than that of the active current, so that the apparent current becomes less than or equal to the limit value.
